(19) United States
(12) Patent Application Publication
(10) Pub. No.: US 2026/0229986 A1
(43) Pub. Date: Aug. 6, 2026

(54) POWER CONVERTER, CONTROLLER, AND METHOD WITH OVERCURRENT PROTECTION

(71) Applicant: SEMICONDUCTOR COMPONENTS INDUSTRIES, LLC, Scottsdale, AZ (US)

(72) Inventors: Michael Scott LAY, Tempe, AZ (US); David H. ELWART, II, Sachse, TX (US); Marian PONCIK, Plano, TX (US); James George Hill, Cave Creek, AZ (US); Han ZOU, Gilbert, AZ (US)

(73) Assignee: SEMICONDUCTOR COMPONENTS INDUSTRIES, LLC, Scottsdale, AZ (US)

(21) Appl. No.: 19/465,588

(22) Filed: Jan. 30, 2026

Related U.S. Application Data
(60) Provisional application No. 63/754,081, filed on Feb. 5, 2025.

(51) Int. Cl. H02M 1/32; H02M 1/00; H02M 1/14; H02M 3/157; H02M 3/158

(52) U.S. Cl. CPC H02M 1/32; H02M 1/0009; H02M 1/143; H02M 3/157; H02M 3/158

(57) ABSTRACT

An illustrative controller includes: a feedback circuit that produces a PWM signal based on an output node voltage; and an overcurrent protection (OCP) circuit configured to convert the PWM signal into (i) a high side control (HSFET) signal for a high side switch, and (ii) a low side control (LSFET) signal for a low side switch. The OCP circuit includes: a high side positive overcurrent detector that de-asserts the HSFET signal and asserts the LSFET signal for a first interval when the current exceeds a first threshold during assertion of the PWM signal; a low side positive overcurrent detector that disables the HSFET signal and asserts the LSFET signal for a second interval when the current exceeds a second threshold during de-assertion of the PWM signal; and a low side negative overcurrent detector that de-asserts the LSFET signal for a third interval when the current falls below a third threshold.

### CROSS-REFERENCE TO RELATED APPLICATIONS

The present application claims benefit of US Application 63/754,081 titled "Overcurrent Protection and filed 2025-02-05 naming inventors Michael S. Lay, David H. Elwart II, Marian Poncik, James G. Hill, and Han Zou. This application is hereby incorporated herein by reference.

### BACKGROUND

Power converters offer the ability to convert between different forms of electrical power, including from a direct current (DC) voltage at, say, 12 V to a DC voltage suitable for integrated electronics, e.g., 1.8 V. A variety of power converter designs are known and used including DC-DC switching converters, which employ one or more switches to provide regulated power transfer by alternate charging and discharging of energy storage elements such as inductors and capacitors. Under extreme load conditions the switches in such designs may be vulnerable to damage from excess current flow. Existing overcurrent protection techniques may not be suitable for all applications.

### SUMMARY

Accordingly, there are disclosed herein a power converter, controller, and conversion method having overcurrent protection. An illustrative controller includes: a feedback circuit configured to produce a pulse width modulated (PWM) signal based on a voltage of an output node; and an overcurrent protection (OCP) circuit configured to convert the PWM signal into (i) a high side control signal for a high side switch configured to increase an inductor current to the output node when the high side control signal is asserted, and (ii) a low side control signal for a low side switch configured to decrease the inductor current when asserted. The OCP circuit includes: a high side positive overcurrent detector configured to disable assertion of the high side control signal and enable assertion of the low side control signal for a first interval if the inductor current exceeds a first threshold during assertion of the PWM signal; a low side positive overcurrent detector configured to disable assertion of the high side control signal and enable assertion of the low side control signal for a second interval if the inductor current exceeds a second threshold during de-assertion of the PWM signal; and a low side negative overcurrent detector configured to disable assertion of the low side control signal for a third interval if the inductor current falls below a third threshold.

An illustrative converter includes: an inductor coupled to supply a current to an output node, the inductor having an inductor terminal; a high side switch coupled between the inductor terminal and a first voltage node to increase the current when a high side control signal is asserted; a low side switch coupled between the inductor terminal and a second voltage node to decrease the current when a low side control signal is asserted; and a controller as described previously.

An illustrative method includes: (1) producing a PWM signal based on a voltage of an output node; and (2) converting the PWM signal into (i) a high side control signal for a high side switch configured to increase an inductor current coupled to the output node when the high side control signal is asserted, and (ii) a low side control signal for a low side switch configured to decrease the inductor current when the low side control signal is asserted. The converting includes: using a high side positive overcurrent detector to disable assertion of the high side control signal and to enable assertion of the low side control signal for a first interval if the inductor current exceeds a first threshold during assertion of the PWM signal; using a low side positive overcurrent detector to disable assertion of the high side control signal and to enable assertion of the low side control signal for a second interval if the inductor current exceeds a second threshold during de-assertion of the PWM signal; and using a low side negative overcurrent detector to disable assertion of the low side control signal for a third interval if the inductor current falls below a third threshold.

Each of the foregoing examples may be employed individually or conjointly, and they may further employ one or more of the following optional features in any suitable combination: 1. the low side negative overcurrent detector is configured to perform said disabling periodically while the current remains below the third threshold. 2. the high side positive overcurrent detector is configured to perform said disabling periodically if the current remains above the first threshold during assertion of the PWM signal. 3. the first interval is greater than or equal to a PWM signal period. 4. the second interval is greater than or equal to a PWM signal period. 5. the third interval is between 0.1 and 0.5 microseconds, inclusive. 6. the OCP circuit includes digital logic gates that combine the PWM signal with outputs of the high side positive overcurrent detector, the low side positive overcurrent detector, and the low side negative overcurrent detector to derive the high side control signal and the low side control signal. 7. the high side switch is a first field effect transistor having a first gate controlled by the high side control signal and the low side switch is a second field effect transistor having a second gate controlled by the low side control signal. 8. the inductor, high side switch, and low side switch are arranged in a buck converter configuration.

### BRIEF DESCRIPTION OF THE DRAWINGS

FIG. 1 is a schematic of an illustrative buck converter.

FIG. 2 is a schematic of an illustrative controller for a DC-DC converter

FIG. 3 is a graph of illustrative signal waveforms for normal operation.

FIG. 4 is a graph of illustrative signal waveforms for high side positive overcurrent protection.

FIG. 5 is a graph of illustrative signal waveforms for low side positive overcurrent protection.

FIG. 6 is a graph of illustrative signal waveforms for low side negative overcurrent protection.

FIG. 7 is a flow diagram for an illustrative overcurrent protection method.

### DETAILED DESCRIPTION

While specific details are provided in the drawings and the following description, they do not limit the disclosure. On the contrary, these details provide the foundation for one of ordinary skill to discern the alternative forms, equivalents, and modifications that are encompassed in the scope of the appended claims.

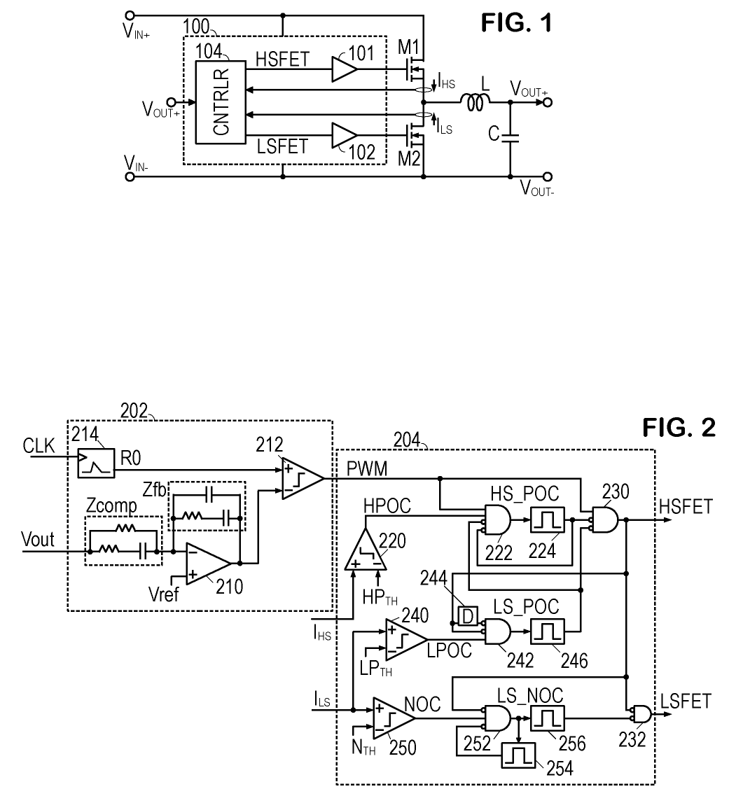

The disclosed overcurrent protection techniques are applicable to a variety of switched converter designs, one of which is shown in FIG. 1 to provide the context for understanding. FIG. 1 shows an illustrative buck converter that operates to convert a DC input voltage between input nodes Vin+, Vin- to a DC output voltage between output nodes Vout+, Vout-. An output capacitor C may be provided between the output nodes to accommodate transients in the load impedance they power. The output capacitor C is charged to the desired output voltage by a current through inductor L.

A high side switch M1 couples the inductor to a first input voltage node Vin+ to increase the inductor current when a high side control signal HSFET is enabled. A low side switch M2 couples the inductor to a second input voltage node Vin- to decrease the inductor current when a low side control signal is asserted. The switches are shown here as enhancement mode n-channel metal-oxide-semiconductor field effect transistors, but other switch implementations would also be suitable. The illustrated transistors each include a body diode, enabling inductor current flow to persist even when the switches are both off.

Based on the output node voltage Vout+, a driver circuit 100 controls the switches M1,M2 as needed to maintain a desired output voltage under expected load conditions. For extreme load conditions, the driver circuit 100 controls the switches subject to constraints that provide overcurrent protection. FIG. 1 shows the driver circuit 100 sensing the high side switch current I_{HS} and low side switch current I_{LS} to facilitate the overcurrent protection. In at least some implementations, this current sensing is implemented by measuring the drain-source voltage V_{DS} of each switch when the switches are on, but other current sensing techniques may alternatively be used. Note that in the following description, the switch currents are each positive for current flow to the output node and negative for current flow to an input node.

The driver circuit 100 includes a controller 104 that derives the high side control signal and the low side control signal from the output node voltage and the switch currents. A buffer 101 provides appropriate scaling and voltage shifting of the high side control signal to operate the high side switch M1. Buffer 102 similarly provides appropriate scaling and, if needed, voltage shifting of the low side control signal to operate the low side switch M2.

In one contemplated implementation, the driver circuit 100 is packaged as a multi-chip module including switches M1,M2, thereby enabling better optimization of the integrated circuit manufacturing processes used for the power transistors and the driver circuit.

FIG. 2 is a schematic for an illustrative implementation of the controller circuit 104. The illustrative implementation includes a feedback circuit 202 and an overcurrent protection (OCP) circuit 204. The illustrated feedback circuit includes an op amp 210 configured as an error filter with a compensation impedance to smooth ripples of the output node voltage and a feedback impedance to provide loop filtering of the error between the filtered output node voltage and a reference voltage. The output of the op amp 210 is a signal representing a filtered error that becomes increasingly positive while the filtered output node voltage exceeds the reference voltage and increasingly negative while the reference voltage exceeds the filtered output node voltage. A comparator 212 compares the filtered error to a ramp signal R0 created by a ramp generator in response to a clock signal CLK. The output of the comparator is a pulse width modulated (PWM) signal having a duty cycle that is smaller for larger values of the filtered error signal and larger for smaller (more negative) values of the filtered error. The period of the PWM signal, which is used below as a convenient time scale unit, corresponds to the period of the clock signal CLK. In one illustrative implementation, the PWM signal period is 4 microseconds, but the range of suitable values is expected to extend from 10 nanoseconds to 10 milliseconds. It is acknowledged here that the PWM signal may achieve 100% duty cycle under some operating conditions, but as a design parameter the PWM signal period is unchanged.

Note that the feedback circuit illustrated here is merely illustrative. Alternative implementations are known, which may offer performance enhancements (e.g., reduced output harmonics), but the given example is sufficient for understanding the disclosed overcurrent protection techniques.

The OCP circuit 204 includes a high side positive overcurrent detection circuit (elements 220-224), a low side positive overcurrent detection circuit (elements 240-246), a low side negative overcurrent detection circuit (elements 250-256), and digital logic to combine the detection circuit outputs with the PWM signal (elements 230-232).

The high side positive overcurrent detection circuit includes a comparator 220 that compares the high side current IHS to a high side positive threshold value (HP_{TH}). A logic gate 222 operates to detect a high side positive overcurrent condition if the output of comparator 220 is asserted while the PWM signal is asserted and the detection is not blocked. The detection causes a one shot (monostable multivibrator) circuit 224 to assert a pulse for a first interval. (Each of the one shot circuits acts as a timer. Alternative implementations may employ alternative timers.) The first interval may nominally equal two periods of the PWM signal while being a parameter that can be programmed in firmware. As a guideline, it is contemplated that the first interval will be greater than or equal to one PWM signal period and more preferably greater than or equal to two PWM signal periods, but in any case may be determined by the expected delay for the inductor current to decay to a desired level. When asserted, the output of the one shot circuit 224 (and the output of the one shot circuit 246, discussed further below) blocks a new detection of the high side positive overcurrent condition.

A logic gate 230 produces the high side control signal HSFET from a combination of the PWM signal with the detection circuit outputs. If the PWM signal is de-asserted, the high side control signal HSFET is de-asserted. If the PWM signal is asserted, the HSFET signal is asserted unless either the output of the one shot 224 is asserted (indicating detection of a high side positive overcurrent condition) or the output of the one shot 246 is asserted (indicating detection of a low side positive overcurrent condition).

A logic gate 232, alone or in combination with logic gate 230, produces the low side control signal LSFET from a combination of the PWM signal with the detection circuit outputs. If the PWM signal is de-asserted, or either of the outputs of one shot 224 and one shot 246 are asserted, the LSFET signal is asserted unless the output of one shot 256 is asserted (indicating detection of a low side negative overcurrent condition). The LSFET signal is de-asserted if the output of one shot 256 is asserted or the PWM signal is asserted while outputs of one shot 224 and 246 are both de-asserted.

The low side positive overcurrent detection circuit includes a comparator 240 that compares the low side current ILS to a low side positive threshold value (LP_{TH}). It is expected that the low side positive threshold value will be lower than the high side positive threshold value, but these thresholds may be set independently based on the vulnerabilities of the high side and low side switches in their contemplated converter configuration. A logic gate 242 operates to detect a low side positive overcurrent condition if the output of the comparator 240 is asserted while the HSFET signal is de-asserted. (A delay element 244 may be included to provide a programmable blanking window preventing low side positive overcurrent detection immediately after a downward transition of the HSFET signal.) This detection causes a one shot circuit 246 to assert its output for a second interval. The second interval may nominally equal one period of the PWM signal, but like the first interval is a parameter that can be programmed in firmware. As a guideline, it is contemplated that the second interval will be greater than or equal to a PWM signal period, but a more rigorous calculation may be determined based on the expected delay for the inductor current to decay to a desired level. When asserted, the output of the one shot circuit 246 blocks assertion of the HSFET signal and blocks detection of a high side positive overcurrent condition.

The low side negative overcurrent detection circuit includes a comparator 250 that compares the low side current ILS to a negative threshold value (N_{TH}). The negative threshold value is contemplated to be a negative of the high side positive threshold value, but will depend on the properties of the low side switch. A logic gate 252 operates to detect a low side negative overcurrent condition if the output of the comparator 250 is asserted while the HSFET signal is de-asserted and the detection is not blocked by assertion of the output of one shot circuit 254. The detection causes a one shot circuit 256 to assert its output for a third interval and a second one shot circuit 254 to assert its output for a fourth interval. The fourth interval may be approximately double the third interval and is preferably significantly less than the PWM signal period, e.g., one eighth of the PWM signal period, one tenth of the PWM signal period. Assertion of the output of one shot circuit 256 causes de-assertion of the LSFET signal.

When the high side control signal and the low side control signal are both de-asserted, negative current flow will route through the body diode of the high side switch. Thus, periodic enabling and disabling of the low side control signal will cause the negative current flow to alternate between the high side and low side switches, causing the associated power dissipation to be shared between them. If the fourth interval is approximately double the third interval, the alternation is given a duty cycle of about 50%, halving the power dissipation in the low side switch during a negative overcurrent.

The intervals and thresholds may be programmable to enable the converter operation to be optimized for the chosen application. The comparators 220, 240, 250 are shown directly comparing the switch currents to the thresholds. In alternative embodiments, the switch currents may be filtered to reduce noise or otherwise improve performance. The logic gates 222, 230, 232, 242, and 252 are illustrated as logical AND gates with selected inputs being inverted, but those skilled in the art will recognize other logic gate implementations can be used to achieve the same result. Though not specifically addressed herein, the operation of gates 230, 232 can be adjusted to ensure soft switching or such related performance optimizations as may be desired.

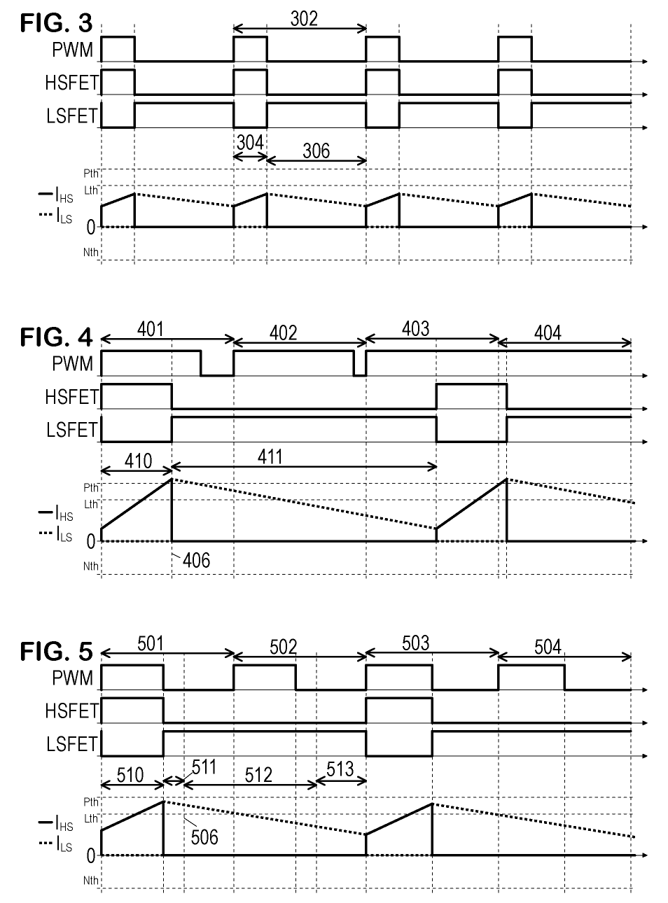

FIG. 3 through FIG. 6 are signal waveforms that may illustrate the different operating conditions of the disclosed converter. As an example of normal operating conditions, FIG. 3 shows periodic assertions of the PWM signal with a PWM signal period 302. The high side control signal HSFET is asserted while the PWM signal is asserted. When the PWM signal is de-asserted the low side control signal LSFET is asserted. In the intervals that the PWM signal is asserted (e.g., interval 304), the high side switch is enabled, enabling the inductor current to increase as the OCP circuit monitors for high side positive overcurrent. In the intervals that the HSFET signal is de-asserted (e.g., interval 306), the low side switch is enabled, enabling the inductor current to ramp downward as the OCP circuit monitors for low side positive overcurrent and for low side negative overcurrent.

As an example of an operating condition that triggers detection of high side positive overcurrent, FIG. 4 shows assertions of the PWM signal with an increasing duty cycle that reaches 100%. Such a condition may be caused by a load that draws current beyond the capabilities of the input power source. In a first PWM signal period 401, the PWM signal is asserted for about 80% of the signal period. While the PWM signal is asserted, the inductor current increases until it exceeds the high side positive overcurrent threshold PTH at time 406. During this interval 410, the OCP circuit monitors for the high side positive overcurrent condition, detecting the overcurrent at time 406 and blocking assertion of the high side control signal HSFET for a first predetermined interval 411 following the detection. Interval 411 is preferably programable, but may nominally be set at twice the PWM period. This blocking suppresses the remainder of the PWM signal assertion in the first signal period 401, all of the PWM signal assertion in the next signal period 402, and a portion of the PWM signal assertion in the third period.

While the high side control signal is de-asserted, the low side control signal is asserted and the OCP circuit monitors for low side negative overcurrent. (Monitoring of low side positive overcurrent may be suppressed during the first predetermined interval 411.) The inductor current ramps downward until the first predetermined interval 411 expires during the third PWM signal period 403. If the PWM signal remains asserted, the OCP circuit reasserts the high side control signal HSFET until the high side positive overcurrent condition reoccurs, and the cycle repeats in a periodic fashion. These suppressions may naturally cause the feedback circuit to sense a larger voltage error and correspondingly increase the duty cycle of the PWM signal until it reaches 100% in PWM periods 403, 404, and onward. Though the converter is unable to maintain the full output voltage until the load demand returns to normal, it delivers a sustainable amount of power while protecting the switches against sustained over current conditions.

As an example of an operating condition that triggers detection of a low side positive overcurrent, FIG. 5 shows assertions of the PWM signal in four PWM signal periods 501-504. While the PWM signal is asserted in the first signal period 501, the high side control signal is asserted. The inductor current increases but does not exceed the positive overcurrent threshold PTH during interval 510. Once the PWM signal is de-asserted, the low side control signal is asserted, causing the inductor current to ramp downward. After an optional blanking window 511 provided by delay element 244, the OCP circuit detects (at time 506) that the inductor current exceeds a low side positive overcurrent threshold LTH. Upon detection, the OCP circuit blocks assertion of the high side control signal for a second predetermined interval 512. Interval 512 is preferably programmable, but may nominally be set approximately equal to the PWM period 501. This blocking suppresses assertion of the high side control signal during the next assertion of the PWM signal, providing additional time for the inductor current to ramp down. Once the interval 512 has elapsed, the OCP circuit resumes monitoring for low side positive overcurrent and for low side negative overcurrent during interval 513, which lasts until the low side overcurrent detection is repeated or until the subsequent assertion of the PWM signal. The OCP circuit accordingly provides overcurrent protection even as the converter approaches the limits of its ability to maintain the output voltage.

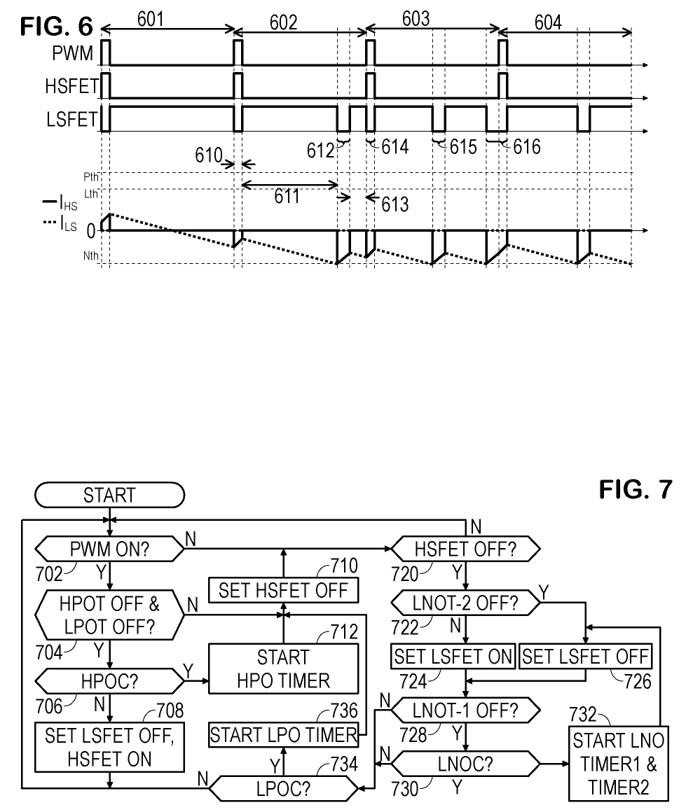

Negative currents are expected only when the power draw of the load quickly drops or reverses, causing the output voltage to exceed the desired value. FIG. 6 shows an example in which the duty cycle of the PWM signal reaches a preset minimum during PWM signal periods 601-604. When the PWM signal is asserted, the high side control signal HSFET is asserted and the low side control signal LSFET is de-asserted. The inductor current increases slightly in these brief intervals, but overall exhibits a steady decrease due to the much longer de-assertions of the high side control signal.

For example, interval 610 corresponds to an assertion of the PWM signal and high side control signal which provide an increase in inductor current. During interval 611, the low side control signal is asserted, enabling the inductor current to become increasingly negative until it falls below the negative overcurrent threshold NTH. The OCP circuit detects the low side negative overcurrent condition and blocks assertion of the low side control signal LSFET for a third predetermined interval 612. The OCP circuit also blocks re-detection of the negative overcurrent for a fourth predetermined interval (not shown), which may be approximately twice the third predetermined interval 612. With the de-assertion of the low side control signal, the inductor current passes through the body diode of the high side switch before reverting to the low side switch when the low side control signal is re-asserted after the interval 612 expires. If the inductor current remains or returns below the negative threshold after the fourth predetermined interval expires, the low side switch is again disabled. Interval 614 corresponds to an assertion of the high side control signal, after which the inductor current again becomes more negative and causes another negative overcurrent detection. Interval 615 corresponds to the OCP's blocking of the low side control signal for the predetermined third interval. A subsequent detection of the negative overcurrent triggers interval 616, which is extended by an assertion of the high side control signal. In this fashion, the OCP circuit regulates the negative overcurrent and distributes the associated power dissipation between the high side and low side switches.

FIG. 7 is a flow diagram of an illustrative overcurrent protection method. Though shown and described here as a sequential process, it should be understood that this is for explanatory purposes. In practice the operations may be distributed across multiple components, enabling the desired functionality to be implemented by operations that occur in a parallel and asynchronous fashion.

In block 702, the OCP circuit determines whether the PWM signal is asserted. If so, the OCP circuit determines in block 704 if the high side positive overcurrent timer (e.g., one shot 224) and the low side positive overcurrent timer (e.g., one shot 246) are inactive. If so, in block 706 the OCP circuit determines if the high side current exceeds the high side positive overcurrent threshold. If not, in block 708 the OCP circuit de-asserts the low side control signal and asserts the high side control signal before returning to block 702.

Returning to block 704, if either the high side positive overcurrent timer or low side positive overcurrent timer is active, the OCP suppresses assertion of the high side control signal in block 710. If, in block 706, the high side overcurrent threshold is exceeded, the OCT circuit starts the high side positive overcurrent timer in block 712 before proceeding to block 710.

The OCP circuit reaches block 720 from block 710 or from block 702 if the PWM signal is de-asserted. The OCP circuit determines whether the high side control signal is de-asserted, and if not, loops back to block 702. If the signal is de-asserted, the OCP circuit in block 722 determines whether the second low side negative overcurrent timer (which during the third predetermined interval blocks assertion of the low side control signal) is inactive. If so, the OCP circuit asserts the low side control signal in block 724. Otherwise, in block 726, the OCP circuit de-asserts the low side control signal.

In either case, the OCP circuit determines in block 728 whether the first low side negative overcurrent timer (which during the fourth predetermined interval blocks detection of the low side negative overcurrent) is inactive. If so, in block 730, the OCP circuit determines whether the low side current falls below the negative overcurrent threshold. If so, in block 732, the OCP circuit starts the first and second low side negative overcurrent timers and proceeds to block 726.

The OCP circuit reaches block 734 if the first low side negative overcurrent timer active or if the current is above the negative overcurrent threshold. In block 734, the OCP circuit determines whether the low side current exceeds the low side positive overcurrent threshold. If not, the circuit loops back to block 702. Otherwise, the OCP circuit starts the low side positive overcurrent timer in block 736 and proceeds to block 710.

The overcurrent protection techniques and designs disclosed herein are thus able to regulate switch currents to minimize vulnerability to damage under extreme load conditions. The foregoing discussion does not expressly address complicating factors such as parasitic impedances, current-limiting resistors, level-shifters, line clamps, etc., which may be present but are known to those of ordinary skill in the art. These and numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A converter that comprises:
an inductor coupled to supply a current to an output node, the inductor having an inductor terminal;
a high side switch coupled between the inductor terminal and a first voltage node to increase the current when a high side control signal is asserted;
a low side switch coupled between the inductor terminal and a second voltage node to decrease the current when a low side control signal is asserted; and
a controller having:
a feedback circuit configured to produce a pulse width modulated (PWM) signal based on a voltage of the output node; and
an overcurrent protection (OCP) circuit configured to convert the PWM signal into the high side control signal and into the low side control signal, the OCP circuit including:
a high side positive overcurrent detector configured to disable assertion of the high side control signal and enable assertion of the low side control signal for a first interval if the current exceeds a first threshold during assertion of the PWM signal;
a low side positive overcurrent detector configured to disable assertion of the high side control signal and enable assertion of the low side control signal for a second interval if the current exceeds a second threshold during de-assertion of the PWM signal; and
a low side negative overcurrent detector configured to disable assertion of the low side control signal for a third interval if the current falls below a third threshold.

2. The converter of claim 1, wherein the third interval is between 0.1 and 0.5 microseconds, inclusive, and wherein the low side negative overcurrent detector is configured to perform said disabling periodically while the current remains below the third threshold.

3. The converter of claim 1, wherein the first interval is greater than or equal to a PWM signal period.

4. The converter of claim 3, wherein the second interval is greater than or equal to a PWM signal period.

5. The converter of claim 1, wherein the high side positive overcurrent detector is configured to perform said disabling periodically if the current remains above the first threshold during assertion of the PWM signal.

6. The converter of claim 1, wherein the OCP circuit includes digital logic gates that combine outputs of the high side positive overcurrent detector, the low side positive overcurrent detector, and the low side negative overcurrent detector, with the PWM signal to derive the high side control signal and the low side control signal.

7. The converter of claim 1, wherein the high side switch is a first field effect transistor having a first gate controlled by the high side control signal and the low side switch is a second field effect transistor having a second gate controlled by the low side control signal.

8. The converter of claim 1, wherein the inductor, high side switch, and low side switch are arranged in a buck converter configuration.

9. A method that comprises:
producing a PWM signal based on a voltage of an output node;
converting the PWM signal into (i) a high side control signal for a high side switch configured to increase an inductor current coupled to the output node when the high side control signal is asserted, and (ii) a low side control signal for a low side switch configured to decrease the inductor current when the low side control signal is asserted, the converting including:
using a high side positive overcurrent detector to disable assertion of the high side control signal and to enable assertion of the low side control signal for a first interval if the inductor current exceeds a first threshold during assertion of the PWM signal;
using a low side positive overcurrent detector to disable assertion of the high side control signal and to enable assertion of the low side control signal for a second interval if the inductor current exceeds a second threshold during de-assertion of the PWM signal; and
using a low side negative overcurrent detector to disable assertion of the low side control signal for a third interval if the inductor current falls below a third threshold.

10. The method of claim 9, wherein the third interval is between 0.1 and 0.5 microseconds, inclusive, and wherein the low side negative overcurrent detector is configured to perform said disabling periodically while the inductor current remains below the third threshold.

11. The method of claim 9, wherein the first interval is greater than or equal to a PWM signal period.

12. The method of claim 11, wherein the second interval is greater than or equal to a PWM signal period.

13. The method of claim 9, wherein the high side positive overcurrent detector is configured to perform said disabling periodically if the inductor current remains above the first threshold during assertion of the PWM signal.

14. The method of claim 9, further comprising: wherein the converting includes using digital logic gates to combine the PWM signal with outputs of the high side positive overcurrent detector, the low side positive overcurrent detector, and the low side negative overcurrent detector.

15. A controller that comprises:
a feedback circuit configured to produce a pulse width modulated (PWM) signal based on a voltage of an output node; and
an overcurrent protection (OCP) circuit configured to convert the PWM signal into (i) a high side control signal for a high side switch configured to increase an inductor current to the output node when the high side control signal is asserted, and (ii) a low side control signal for a low side switch configured to decrease the inductor current and into the low side control signal, the OCP circuit including:
a high side positive overcurrent detector configured to disable assertion of the high side control signal and enable assertion of the low side control signal for a first interval if the inductor current exceeds a first threshold during assertion of the PWM signal;
a low side positive overcurrent detector configured to disable assertion of the high side control signal and enable assertion of the low side control signal for a second interval if the inductor current exceeds a second threshold during de-assertion of the PWM signal; and
a low side negative overcurrent detector configured to disable assertion of the low side control signal for a third interval if the inductor current falls below a third threshold.

16. The controller of claim 15, wherein the third interval is between 0.1 and 0.5 microseconds, inclusive, and wherein the low side negative overcurrent detector is configured to perform said disabling periodically while the inductor current remains below the third threshold.

17. The controller of claim 15, wherein the first interval is greater than or equal to a PWM signal period.

18. The controller of claim 17, wherein the second interval is greater than or equal to a PWM signal period.

19. The controller of claim 15, wherein the high side positive overcurrent detector is configured to perform said disabling periodically if the inductor current remains above the first threshold during assertion of the PWM signal.

20. The controller of claim 15, wherein the OCP circuit includes digital logic gates that combine outputs of the high side positive overcurrent detector, the low side positive overcurrent detector, and the low side negative overcurrent detector, with the PWM signal to derive the high side control signal and the low side control signal.
